(19) United States
(12) Patent Application Publication
(10) Pub. No.: US 2006/0288115 A1
(43) Pub. Date: Dec. 21, 2006

(54) A System and Method for transferring a website from one web host to another

(76) Inventor: Ben Neuman, Los Angeles, CO (US)

Correspondence Address: JEFFREY FURR, 253 N. MAIN STREET, JOHNSTOWN, OH, 43031, US

(21) Appl. No.: 10/908,954

(22) Filed: Jun. 1, 2005

(51) Int. Cl. G06F 15/16

(52) U.S. Cl. 709/232

(57) ABSTRACT

The current invention is designed to simplify the process it takes to transfer a website from one web host to another. The system will transfer a user's information through a series of easy to follow screens, similar to a Microsoft Windows wizard. The system will support the transfer of all HTML files and scripts form all of the major hosting panels such as Cpanel, Plesk, Vdeck and more, as well as transferring the necessary files, it will also allow users to create up to five E-mail accounts during the session. In addition, the system will support the importing ability of control panel exports form all of the major control panels. This will allow the system 1 to move the necessary files over, as well as E-mail addresses and database content.

### BACKGROUND OF INVENTION

1. Field of the Invention

The present invention relates to techniques for transferring a website from one webhost to another.

2. Description of Prior Art

The World Wide Web is currently a subject of intense and rapidly growing interest. The World Wide Web is composed of interconnected data sources that are accessible to computer users through data-communication networks such as the Internet. The data available on the World Wide Web has been assembled by private individuals, commercial companies, government agencies, and special interest organizations. Much of this assembled information is organized into Web pages. A Web site is a collection of Web pages (and possibly other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to users of the World Wide Web through a software program known as a Web server. A network user uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java bytecode), and other content to be downloaded to the client computer or displayable through client software programs that add to the browser's functionality (sometimes referred to as “browser plug-ins”).

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

More and more businesses and people are owning, running and transferring websites. Currently transferring a website from one entity to another can be time consuming and difficult.

U.S. Pat. No. 6,880,007 by Gardos, et al. and issued on Apr. 12, 2005, is for a domain manager and method of use. It discloses a program running on a web server allows automated domain name registration, modification and management through an interface running on a client machine. The program redefines the concept of the Domain Name System zones by breaking them down into discrete records that can be managed in a database.

U.S. Pat. No. 6,873,957 by Chen, et al. and issued on Mar. 29, 2005, is for a system and method for replicating web-sites. It discloses a computer-implemented method for replicating Websites in a digital network. The method comprises converting a website into a Super Site, wherein the Super Site may be replicated. One or more Sub Sites is generated from the Super Site. The behaviors of the Sub Sites are configured to match desired population segment characteristics.

U.S. Pat. No. 6,338,082 by Schneider and issued on Jan. 8, 2002, is for a method, product, and apparatus for requesting a network resource. It discloses an invention in which when a network resource request having a domain name is received, it is determined whether the network resource can be located including determing whether the domain name is resolvable.

U.S. Pat. No. 6,298,341 by Mann, et al. and issued on Oct. 2, 2001, is for a system and method for generating domain names and for facilitating registration and transfer of the same. It discloses new and improved systems and methods for generating and facilitating registration and transfer of available domain names. The systems and methods include and involve a data storage facility for storing at least one adjunct term for use in generating at least one registerable domain name, and a processor arrangement which is coupled to the data storage facility and which is configured to be accessed by a user system via an electronic data network, to receive at least one root term from the user system, to concatenate at least one root term with at least one adjunct term to generate at least one candidate domain name, to query a data source to determine if the candidate domain name(s) is available for registration and/or transfer, and to notify the user system of the candidate domain name(s) when the same are available for registration and/or transfer.

United States Patent Application 20030033378 by Needham, et al. and published on Feb. 13, 2003, is for a method and apparatus for automatically creating and dynamically managing websites. It discloses a system for creating and dynamically managing websites includes a set of tables; a database associated with the set of tables; and a software tool for generating a web interface based on the database using the set of tables. A method for creating and dynamically managing websites includes creating a set of tables associated with a database; and generating a web interface based on the database using the set of tables.

There is still room for improvement in the art.

### SUMMARY OF INVENTION

The current invention is designed to simplify the process it takes to transfer a website from one web host to another. The system will transfer a user's information through a series of easy to follow screens, similar to a Microsoft Windows wizard. The system will support the transfer of all HTML files and scripts form all of the major hosting panels such as Cpanel, Plesk, Vdeck and more, as well as transferring the necessary files, it will also allow users to create up to five E-mail accounts during the session. In addition, the system will support the importing ability of control panel exports form all of the major control panels. This will allow the system 1 to move the necessary files over, as well as E-mail addresses and database content.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The system is more efficient, effective, accurate and functional than the current art.

### DEFINITIONS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its

raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2 shows the system's Sales Element; and

FIG. 3 displays the system's Application Element.

### DETAILED DESCRIPTION

The following description is demonstrative in nature and is not intended to limit the scope of the invention or its application of uses.

There are a number of significant design features and improvements incorporated within the invention.

The current invention is designed to simplify the process it takes to transfer a website from one web host to another. The system will transfer a user's information through a series of easy to follow screens, similar to a Microsoft Windows wizard. The system will support the transfer of all HTML files and scripts form all of the major hosting panels such as Cpanel, Plesk, Vdeck and more, as well as transferring the necessary files, it will also allow users to create up to five E-mail accounts during the session. In addition, the system will support the importing ability of control panel exports form all of the major control panels. This will allow the system 1 to move the necessary files over, as well as E-mail addresses and database content.

The end result will be a complete solution for transferring hosting accounts.

The computer application that includes the user interface for this invention will henceforth be referred to as “the System 1.” The system is network based and works on an Internet, Intranet and/or Wireless network basis as well as a stand alone and fax based system.

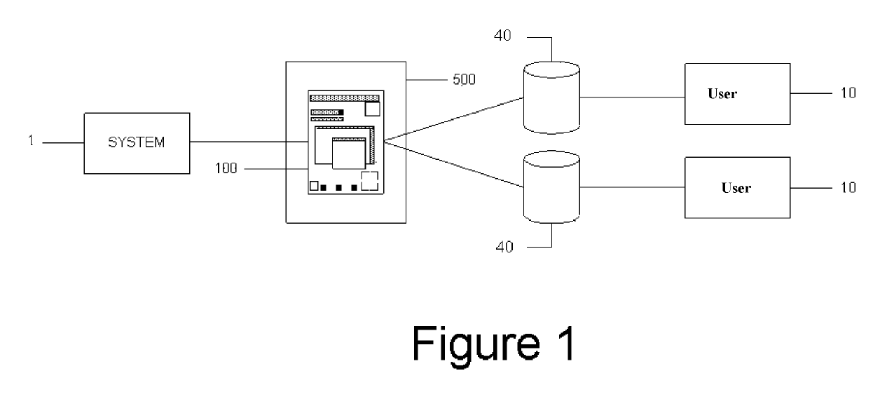

FIG. 1 illustrates a functional diagram of a computer network for World Wide Web 500 access to the System 1 from a plurality of Users 10 who accesses the system Web Site 100 or the Users 10 can connect directly to the System 1 using their computer 35. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon.

The Users 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 connect to the System Web Site 100. In the preferred embodiment the system has numerous web pages. The information in the web pages are in HTML format via the HyperText Transport Protocol (http) and on Server System 310. The User System 310 includes software to allow viewing of web pages, commonly referred to as a Web Browser, such as Communicator available from Netscape Communications Corp. or Internet Explorer available from Microsoft Corp. The user system is capable of accessing web pages located on Server System 310.

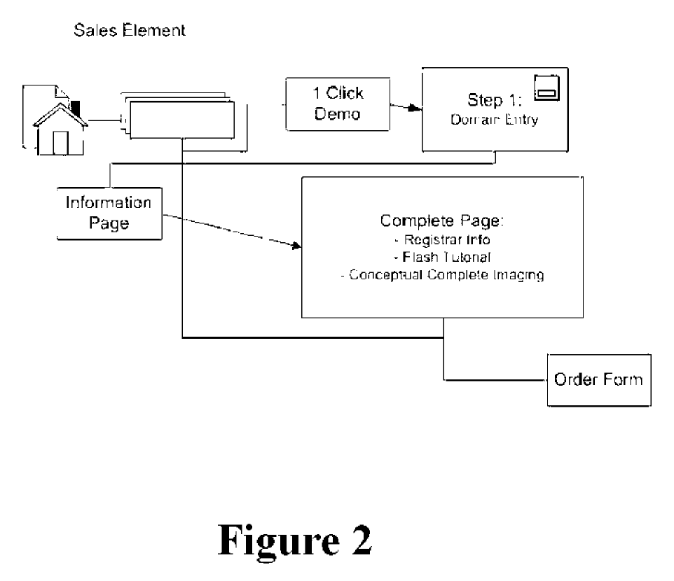

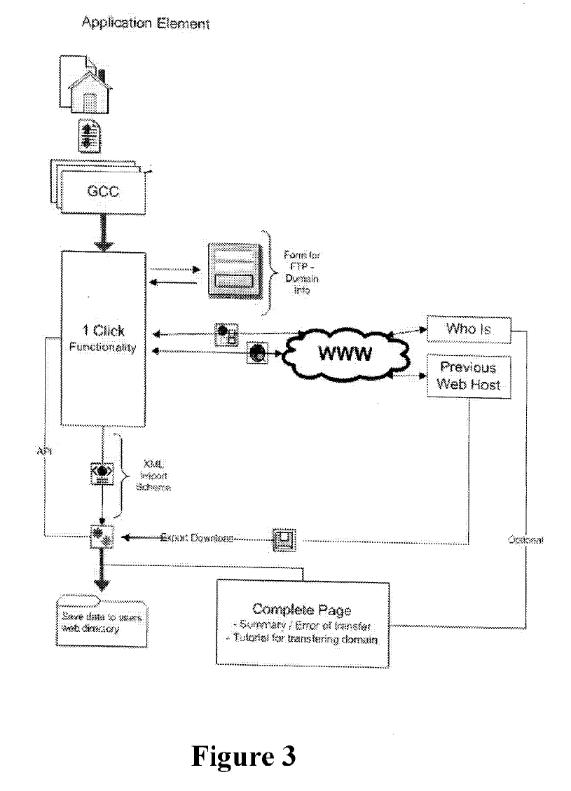

The system 1 had two major components; first is the sales portion as show in FIG. 2, and second is the actual functional portion as shown in FIG. 3.

The sales portion of the system 1, as shown in FIG. 1, is designed to show potential customers the abilities of this system 1, and additionally the ability to “test drive” the system 1. Potential customers will view this demo form the website 100, prompted from a particular content page. The test drive will allow users to enter their FRO and login information for their current hosing account and allow the system 1 to download a few gages to demonstrate it abilities.

The sales demo functions as follows:

1. The user 10 will go through a series of 3 screens.

2. At the first screen the user will type the domain name that will allow the system 1 to do a register lookup and figure out which register company registered the domain name.

3. The second screen will have general information about transfer process. This screen can be combined with screen 1.

4. On the third screen the users 10 will choose the hosting company they are moving from and domain name registering company. This selection actually does not perform any actions.

The actual functional portion of the system 1 is shown in FIG. 3. The function portion of the system 1 is the portion which will be accessible through the website command console. This portion of the system 1 will do all the actual work for the transferring process. Once the customer chooses to transfer their account from another web host to another and chosen transfer in the command console they will have to go through a series of screens.

On the first screen, the users 10 will type in their FTP information as well as they will have domain name field with the domain name filled in already as the information was taken from the domain name database. Based on that domain they system 1 will do a registrar lookup to figure out the company that registered the domain name, what control panel they are on, what version of the control panel they are on for support reasons, The information regarding that registrar is currently will allows selecting the correct Flash tutorial on the final screen.

If there is a connection error, or any other type of error before transferring begins, the users 10 will be automatically redirected back to the first page with the corresponding error message appearing.

If a field is blank or in correctly formatted, the field will be highlighted and an error message will appear.

On the second screen users 10 will see the process and confirmation that their transfer is finished. This page will show a progress meter to demonstrate the percent of completion for the download and import of their data. Functionality should support the chance of the user 10 ending the Internet or browser session, while still completing the transfer and import.

This page should show an itemized list of processes that are taking palce during this step. For example, the list will show: connection . . . complete, Verifying user information . . . complete, connection to Plesk Contorl panel . . . complete, and Downloading export of website.

Under each time, a progress meter should appear if the item will take longer then five to ten seconds. In regard to the “downloading export” function, the progress meter may show for a while.

The progress meter will be a graphical representation in the preferred embodiment of the progress such as a gauge or a bar being filled in.

The backend functionality should be able to identify what type of control pane that is currently being used. This will allow for the correction import schema to be used.

The system's import functionality should support multiple version of the same control panel. It should also support an easy way to get more control panels added as new styles are developed. An API or AFI style format to be used. Possibly using XML for the import rules.

Once a connection is established, a SSH session should be created in order to send command-line commands to the control panel to activate the export.

If the current control panel does not support command-line commands to initiate the export, then the user 10 will be prompted with an input field to enter the location of the export file for download.

If the control panel that is currently being used is not supported, not recognizable, or unable to be located; at that pint the user 10 will be prompted with options. These options are: chose the control panel type with location of export file, if the user selects to choose the control panel type and enter the location, additional checking will take place to verify this information is usable; allow user to do the basic import of file only; or Cancel the transfer.

Once the transfer is complete the system 1 will begin to manipulate the export file form the previous host. Scripts will be scanned through to find paths. These paths will be changed accordingly. In addition, these files will be set with correct security settings to allow them to operate correctly. If a script has an interface to the database, since the system 1 imported previous setting, the passwords would have stayed the same.

Once this process is complete, the page will display a summary of services completed.

On the third screen, the user 10 will see the link to the tutorial of how to transfer the domain name which is selected by the domain name register company.

If their files couldn't be transferred because of PHP/MySQL or any other custom cases the user 10 will get the message explaining to him that he should contact the system administrator. Once the user completes the transferring process, the files and database will be moved into their live we directory. At this point, the website should function as it did before on the previous web host.

The system 1 is set to run on a computing device. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system of transferring web sites from one hosting company to another, the method comprising:
Having a user enter their FTP information; and
Having said user initiating the transferring.

2. The method as described in claim 1, further comprising having said initiating is done through a key click.

3. The method as described in claim 1, further comprising displaying the status of the transfer.

4. The method as described in claim 3, further comprising having the steps of displaying the connection status, displaying the user information, displaying the connection to a control panel and displaying the downloading the export of the website.

5. The method as described in claim 3, further comprising display said status through a graphical representation.

6. The method as described in claim 1, further comprising displaying a progress meter if a process is taking more than a standard amount of time.

7. The method as described in claim 1, further comprising having a command console to enter the data into and to transfer said web site.

8. The method as described in claim 7, further comprising once a connection is established a SSH session is create in order to send command-line commands to said control panel to activate the export.

9. The method as described in claim 8, further comprising, if said control panel does not support said commands to activate said export a message is sent to said user.

10. The method as described in claim 9, further comprising if said export is not support the user will be prompted with options.

11. The method as described in claim 10, wherein said option is to choose the control panel type.

12. The method as described in claim 10, wherein said option is to allow user to do the basic import of files only.

13. The method as described in claim 10, wherein said option is to allow user to cancel said transfer.

14. The method as described in claim 8, further comprising, manipulating said export file once the transfer is complete.

15. The method as described in claim 14, further comprising scanning scripts to find paths and changing said paths.

16. The method as described in claim 1, further comprising once said transfer is complete moving files and databases to their live web directory.

17. The method as described in claim 1, further comprising:
having a sales demo function.

18. The method as described in claim 17, further comprising: having said user type in a domain name into said sale demo function.

19. The method as described in claim 1, further comprising contacting said user if their files can not be transferred.

20. The method as described in claim 1, further comprising having two major components a sales portion and an actual functional portion.
